(19) United States
(12) Patent Application Publication
(10) Pub. No.: US 2020/0029180 A1
(43) Pub. Date: Jan. 23, 2020

(54) METHOD, DEVICE AND SYSTEM FOR BROADCASTING SYSTEM INFORMATION

(71) Applicant: YULONG COMPUTER TELECOMMUNICATION SCIENTIFIC (SHENZHEN) CO., LTD., Shenzhen, Guangdong (CN)

(72) Inventors: Yi-Xue LEI, Shenzhen (CN); Yun-Fei ZHANG, Shenzhen (CN)

(73) Assignee: Yulong Compuuter Telecommunication Scientific (Shenzhen) Co., Ltd., Shenzhen, Guangdong (CN)

(21) Appl. No.: 16/335,803

(22) PCT Filed: Dec. 28, 2016
(86) PCT No.: PCT/CN2016/112729

§ 371 Date: Mar. 22, 2019

(30) Foreign Application Priority Data
Sep. 24, 2016 (CN) 201610848940.5

(51) Int. Cl. H04W 4/06; H04W 72/00; H04W 8/24; H04W 80/02; H04W 76/27; H04W 74/08

(52) U.S. Cl. CPC H04W 4/06; H04W 72/005; H04W 74/0833; H04W 80/02; H04W 76/27; H04W 8/24

(57) ABSTRACT

The present disclosure provides a method for broadcasting system information. The method includes: obtaining preset global system information, the global system information including pre-divided basic system information and terminal-related system information; broadcasting the basic system information on a broadcast channel; receiving a message uploaded by User Equipment (UE) through an uplink channel, and extracting a system information requirement message included in the message; determining target system information in the terminal-related system information according to an indication of the system information requirement message. By adopting the present disclosure, there is no need to send all system information to a terminal at one time, thereby occupying less capacity resources of a base station broadcast channel and improving resource utilization of the broadcast channel.

This application claims priority of Chinese Patent Application No. 201610848940.5, entitled “Method, Device and System for Broadcasting System Information,” filed on Sep. 24, 2016 in the China National Intellectual Property Administration (CNIPA), the entire contents of which are incorporated by reference herein.

### FIELD

The embodiments of the present disclosure relates to a technical field of computer, specifically a method, a device, and a system for broadcasting system information.

### BACKGROUND

With development of communication technologies, communication protocols are also more and more loaded. For example, in a Long Term Evolution (LTE) system in a conventional technology, system information that a base station needs to broadcast to User Equipment (UE) is very complicated, the system information includes a Main Information Block (MIB) and a plurality of System Information Blocks (SIBs). In the MIB, a downlink system bandwidth, a Physical Hybrid ARQ Indicator Channel (PHICH) resource indication, a System Frame Number (SFN), a Cyclic Redundancy Check (CRC) with a mode of mask, information of a number of antennas and other system information have been defined. In addition to the MIB, the number of the plurality of SIBs which has been defined is more than 20. In the conventional technology, broadcast of the system information needs to occupy a broadcast channel, and an adopted level of modulation and demodulation needs to satisfy coverage of centers and edges of terminals, thus capacity resources of a broadcast channel of a base station is mostly occupied, thereby causing a low resource utilization rate of the broadcast channel.

### SUMMARY

Based on this, in order to solve a technical problem in traditional technology that broadcast of system information needs to occupy a broadcast channel and an insufficient resource utilization of the broadcast channel due to an adopted level of modulation and demodulation needs to meet coverage of terminals at a center and edges, a method for broadcasting system information is provided.

A method for broadcasting system information includes:

Obtaining preset global system information, the global system information including pre-divided basic system information and terminal-related system information;

Broadcasting the basic system information on a broadcast channel;

Receiving a message uploaded by User Equipment (UE) through an uplink channel, and extracting a system information requirement message included in the message;

Determining target system information in the terminal-related system information according to an indication of the system information requirement message;

Sending the target system information to the UE.

In one embodiment, receiving the message uploaded by the UE through the uplink channel includes:

Receiving the message uploaded by the UE through an uplink channel of uplink physical layer signaling, Random Access Channel (RACH) or Media Access Control (MAC) signaling; and

Sending the target system information to the UE includes:

Adding the target system information on the broadcast channel.

In one embodiment, receiving the message uploaded by the UE through the uplink channel includes:

Receiving the message uploaded by the UE through the uplink channel of uplink Radio Resource Control (RRC) signaling;

Sending the target system information to the UE includes:

Sending the target system information to the UE through a dedicated channel corresponding to the uplink RRC signaling.

In one embodiment, the system information requirement message is UE capability information or service requirement information.

In one embodiment, extracting the system information requirement message included in the messages includes:

Extracting the system information requirement message included in the messages in an explicit manner or an implicit manner.

In addition, in order to solve a technical problem in traditional technology that broadcast of system information needs to occupy a broadcast channel and an insufficient resource utilization of the broadcast channel due to an adopted level of modulation and demodulation needs to meet coverage of terminals at a center and edges, a device for broadcasting system information is provided.

A device for broadcasting system information includes:

A global system information obtaining module configured to obtain preset global system information, the global system information including pre-divided basic system information and terminal-related system information;

A basic system information broadcasting module configured to broadcast the basic system information on a broadcast channel;

A message uploaded receiving module configured to receive a message uploaded by User Equipment (UE) through an uplink channel, and extract a system information requirement message included in the message;

A target system information determination module configured to determine target system information in the terminal-related system information according to an indication of the system information requirement message;

A target system information sending module configured to send the target system information to the UE.

In one embodiment, the message uploaded receiving module is further configured to receive the message uploaded by the UE through an uplink channel of uplink physical layer signaling, Random Access Channel (RACH) or Media Access Control (MAC) signaling; and

The target system information sending module is further configured to add the target system information on the broadcast channel.

In one embodiment, the message uploaded receiving module is further configured to receive the message uploaded by the UE through the uplink channel of uplink Radio Resource Control (RRC) signaling;

The target system information sending module is further configured to send the target system information to the UE through a dedicated channel corresponding to the uplink RRC signaling.

In one embodiment, the system information requirement message is UE capability information or service requirement information.

In one embodiment, the message uploaded receiving module is further configured to extract the system information requirement message included in the messages in an explicit manner or an implicit manner.

In addition, in order to solve a technical problem in traditional technology that broadcast of system information needs to occupy a broadcast channel and an insufficient resource utilization of the broadcast channel due to an adopted level of modulation and demodulation needs to meet coverage of terminals at a center and edges, a method for receiving system information is provided.

A method for receiving system information includes:

Detecting broadcast channels of two or more than two cells;

Receiving two or more than two sets of system information through the broadcast channels, each one of the two or more than two sets of system information corresponding to a corresponding cell;

Splicing and integrating the two or more than two sets of system information into system information actively broadcast by the cell, and performing a communication service according to the system information actively broadcast by the cell.

In one embodiment, the two or more than two cells include a primary cell and a secondary cell;

Receiving the two or more than two sets of system information through the broadcast channels includes:

Receiving cell-specific system information by a broadcast channel of the primary cell in the two or more than two cells, and receiving cell-shared system information by a broadcast channel of the secondary cell in the two or more than two cells.

In one embodiment, after splicing and integrating the two or more than two sets of system information into system information actively broadcast by the cell, the method further includes:

Determining whether the system information actively broadcast by the cell meets User Equipment (UE) capability information or service requirement information, and when the system information actively broadcast by the cell does not meet the UE capability information or the service requirement information, reporting the UE capability information or the service requirement information to the primary cell in the two or more than two cells through an uplink channel;

Receiving supplemental system information sent by the primary cell according to the UE capability information or the service requirement information;

Performing the communication service according to the system information integrated by the system information actively broadcast by the cell and the supplementary system information.

In one embodiment, the primary cell is a small cell, and the secondary cell is a macro cell.

In addition, in order to solve a technical problem in traditional technology that broadcast of system information needs to occupy a broadcast channel and an insufficient resource utilization of the broadcast channel due to an adopted level of modulation and demodulation needs to meet coverage of terminals at a center and edges, a device for receiving system information is provided.

A device for receiving system information includes:

A cells detection module configured to detect broadcast channels of two or more than two cells;

A system information receiving module configured to receive two or more than two sets of system information through the broadcast channels, each one of the two or more than two sets of system information corresponding to a corresponding cell;

A system information integrating module configured to splice and integrate the two or more than two sets of system information into system information actively broadcast by the cell, and perform a communication service according to the system information actively broadcast by the cell.

In one embodiment, the two or more than two cells include a primary cell and a secondary cell;

The system information receiving module is further configured to receive cell-specific system information by a broadcast channel of the primary cell in the two or more than two cells, and receive cell-shared system information by a broadcast channel of the secondary cell in the two or more than two cells.

In one embodiment, the device further includes a supplemental information request module configured to determine whether the system information actively broadcast by the cell meets User Equipment (UE) capability information or service requirement information, and when the system information actively broadcast by the cell does not meet the UE capability information or the service requirement information, report the UE capability information or the service requirement information to the primary cell in the two or more than two cells through an uplink channel, and receive supplemental system information sent by the primary cell according to the UE capability information or the service requirement information, and perform the communication service according to the system information integrated by the system information actively broadcast by the cell and the supplementary system information.

In one embodiment, the primary cell is a small cell, and the secondary cell is a macro cell.

In addition, in order to solve a technical problem in traditional technology that broadcast of system information needs to occupy a broadcast channel and an insufficient resource utilization of the broadcast channel due to an adopted level of modulation and demodulation needs to meet coverage of terminals at a center and edges, a method for broadcasting system information is provided.

A method for broadcasting system information based on two or more than two cells, includes:

Determining respective corresponding system information by the two or more than two cells;

Sending the respective corresponding system information to User Equipment (UE) through respective broadcast channels by the two or more than two cells, to make the UE receive two or more than two sets of system information, and each set of system information corresponding to corresponding cells, and to make the UE splice and integrate the two or more than two sets of system information into system information actively broadcast by the cell, and performing a communication service according to the system information actively broadcast by the cell.

In one embodiment, the two or more than two cells include a primary cell of the UE and a secondary cell of the UE;

Sending the respective corresponding system information to the UE through the respective broadcast channels by the two or more than two cells includes:

Sending cell-specific system information to the UE through a broadcast channel by the primary cell of the UE;

Sending cell-shared system information to the UE through a broadcast channel by the secondary cell of the UE.

In an embodiment, after sending the respective corresponding system information to the UE through the respective broadcast channels by the two or more than two cells, the method further includes:

Receiving messages uploaded by the UE through an uplink channel, and extracting UE capability information or service requirement information included in the messages by the primary cell of the UE;

Determining supplemental system information according to an indication of the UE capability information or the service requirement information;

Sending the supplementary system information to the UE to make the UE perform the communication service according to the system information integrated by the system information actively broadcast by the cell and the supplementary system information.

In addition, in order to solve a technical problem in traditional technology that broadcast of system information needs to occupy a broadcast channel and an insufficient resource utilization of the broadcast channel due to an adopted level of modulation and demodulation needs to meet coverage of terminals at a center and edges, a system for broadcasting system information is provided.

A system for broadcasting system information including two or more than two cells, the two or more than two cells are configured to determine respective corresponding system information by the two or more than two cells;

The two or more than two cells are configured to send the respective corresponding system information to User Equipment (UE) through respective broadcast channels by the two or more than two cells, to make the UE receive two or more than two sets of system information, and each set of system information corresponding to corresponding cells, and to make the UE splice and integrate the two or more than two sets of system information into system information actively broadcast by the cell, and perform a communication service according to the system information actively broadcast by the cell.

In one embodiment, the two or more than two cells include a primary cell of the UE and a secondary cell of the UE;

The primary cell of the UE is configured to send cell-specific system information to the UE through a broadcast channel;

The secondary cell of the UE is configured to send cell-shared system information to the UE through a broadcast channel.

In an embodiment, the primary cell of the UE is configured to receive messages uploaded by the UE through an uplink channel, and extract UE capability information or service requirement information included in the messages, and determine supplemental system information according to an indication of the UE capability information or the service requirement information, and send the supplementary system information to the UE to make the UE perform the communication service according to the system information integrated by the system information actively broadcast by the cell and the supplementary system information.

Implementation of embodiments of the present disclosure has the following beneficial effects:

After adopting a method, a device, and a system for broadcasting system information as described above, a base station only needs to use less broadcast resources to broadcast preset basic system information. After User Equipment (UE) receives the basic system information through a broadcast channel, when the basic system information adapts capabilities of the UE or meets service requirements of the UE, a corresponding communication service may be performed. Only when the basic system information does not adapt to the capabilities of the UE or does not meet the service requirements of the UE, the base station needs to send the system information required by the UE to the UE. Thus a number of SIBs defined by a timely communication protocol is more, and less resources of the broadcast channel are consumed to send the system information to the base station, thereby improving resource utilization of the broadcast channel.

### BRIEF DESCRIPTION OF THE DRAWINGS

In order to describe the technical solutions in embodiments of the present disclosure or in the prior art more clearly, the following briefly introduces the accompanying drawings needed for describing the embodiments or the prior art. The accompanying drawings in the following description show some embodiments of the present disclosure, and persons of ordinary skill in the art may still derive other drawings from these accompanying drawings without creative efforts.

FIG. 1 is a schematic flowchart diagram of a method for broadcasting system information in an embodiment of the present disclosure;

FIG. 2 is a timing sequence diagram of sending system information by a base station in 5th-Generation New Radio (5G NR) scenarios in the embodiment of the present disclosure;

FIG. 3 is a flowchart diagram of the method for broadcasting system information in the embodiment of the present disclosure;

FIG. 4 is a topology diagram of a coverage scenario of a plurality of cells in the embodiment of the present disclosure;

FIG. 5 is another topology diagram of a coverage scenario of a plurality of cells in the embodiment of the present disclosure;

FIG. 6 is another topology diagram of a coverage scenario of a plurality of cells in the embodiment of the present disclosure;

FIG. 7 is a schematic flowchart diagram of a method for receiving system information in the embodiment of the present disclosure;

FIG. 8 is a schematic diagram of a device for broadcasting system information in the embodiment of the present disclosure;

FIG. 9 is a schematic diagram of a device for receiving system information in the embodiment of the present disclosure;

FIG. 10 is a schematic diagram of a base station in the embodiment of the present disclosure;

FIG. 11 is a schematic diagram of a terminal in the embodiment of the present disclosure.

### DETAILED DESCRIPTION

The following clearly and completely describes the technical solutions in the embodiments of the present disclosure with reference to the accompanying drawings in the embodiments of the present disclosure. The described embodiments are only a part rather than all of the embodiments of the present disclosure. All other embodiments acquired by persons of ordinary skill in the art based on the embodiments of the present disclosure without creative efforts shall fall within the protection scope of the present disclosure.

In order to solve a technical problem in traditional technology that a broadcast of system information needs to occupy a broadcast channel and an insufficient resource utilization of the broadcast channel due to an adopted level of modulation and demodulation needs to meet coverage of terminals at a center and edges, in an embodiment, a method for broadcasting system information is provided, the method is based on a base station subsystem. In a Long Term Evolution (LTE) system, the concept of a base station is an evolved base station E-Node B (eNB).

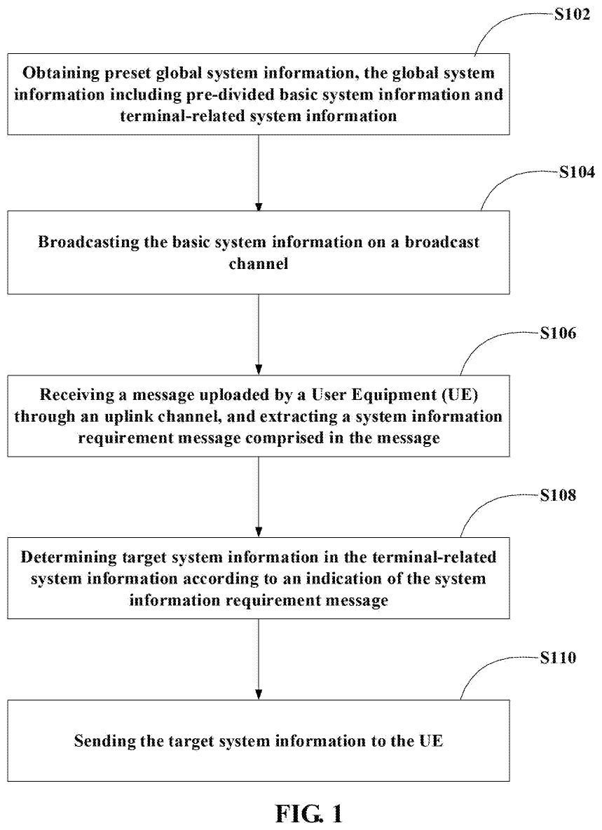

Specifically, as shown in FIG. 1, the above method for broadcasting system information includes the following steps S102-S108.

S102, obtaining preset global system information, the global system information including pre-divided basic system information and terminal-related system information.

The system information includes a plurality of parameters, the parameters mainly includes network attribute information, timers required by User Equipment (UE), common channel information, cell selection, reselection and measurement information. The parameters determine residing, reselection, and call of the UE in a cell. The UE can reside in the cell only when the UE receives all necessary system information.

The system information can include a Main Information Block (MIB) and a plurality of System Information Blocks (SIBs), and scheduling information of the SIBs. The MIB includes a plurality of attributes, as shown in Table 1.

TABLE 1

| | |
|---|---|
| Channel_Type | Indicating a channel type occupied by signaling |
| Direction | Indicating a signaling direction, and a direction of |
| | downlink signaling is 0, a direction of uplink |
| | signaling is 1 |
| Management | An Mib-value tag, which is an integer between 1 and |
| Information | 8, and when the Mib-value tag is modified, value of |
| Base (Mib)- | the Mib-value tag changes |
| Value Tag | |
| Support Public | Supported PLMN type, and a value range of (Global |
| Land Mobile | System For Mobile Communications MAP (GSM- |
| Network | MAP), AMERICAN NATIONAL STANDARDS |
| (PLMN)-Type | INSTITUTE 41 (ANSI-41)) |
| PLMN | Service cell PLMN, which includes Mobile Country |
| identity | Code (MCC) and Mobile Network Code (MNC) |

There are a plurality of types of the SIB according to a communication protocol. In the LTE system, a number of the SIB is defined by more than 20. For example, an SIB 1 mainly includes Network Attached Storage (NAS) information and related parameters of times when the UE in an idle and connected mode, and an SIB 3 and an SIB 4 mainly include parameters of cell selection and reselection. An SIB 5 mainly includes related parameters of a common physical channel in the cell; and an SIB 6 mainly includes related parameters of the common physical channel and a shared physical channel in the cell, etc.

The scheduling information of the SIB describes a location where the SIB appears, and a cycle that the SIB appears, etc. As the SIB may be segmented, the scheduling information of the SIB also includes segmentation scheduling information.

In the embodiment, the global system information includes all system information supported by the communication protocol. For example, in the LTE system, the global system information includes all defined MIBs and SIBs of the LTE system. The pre-divided basic system information is a predefined subset in the global system information, for example, the pre-divided basic system information can include an MIB and a partial SIB, and the MIB or the SIB included in the subset is necessary system information, which is predefined to be broadcast to a terminal through a broadcast channel. The terminal-related system information is predefined optional system information, and the terminal-related system information does not need to be broadcast to the terminal all at once, and can be additionally sent to the terminal according to terminal demands.

For example, when predefined global system information includes the MIB and 20 SIBs according to an LTE communication protocol, the MIB and the SIB 1 to an SIB 9 can be pre-defined as the basic system information, and remaining SIB 10 to SIB 20 are terminal-related system information.

S104, broadcasting the basic system information on a broadcast channel.

For example, in the LTE system, the basic system information can be broadcast on the broadcast channel by the eNB.

S106, receiving a message uploaded by a UE through an uplink channel, and extracting a system information requirement message included in the message.

In the embodiment, the system information requirement message can be UE capability information or service requirement information.

The UE capability information can include a radio access related capability and a core network related capability. When a network side makes various event decisions or executes various algorithms, the network side needs to know capabilities of the UE to make a most appropriate determination. For example, when the UE supports a Circuit Switched Fallback (CSFB) to initiate joint attachment, a process of executing and processing by the network side can be different. When the UE does not support a mobility of the Packet Service Handover (PS HO) inter-RAT, the network can only adopt a National Association of Career Colleges/a Cell Change Order (NACC/CCO) or Redirect to allow interoperation between the systems. The UE can send the UE capability information to the base station through UE capability information signaling. The service requirement information includes services the UE needs to implement when performing a communication service.

In the embodiment, the base station can extract the system information requirement message included in the messages in an explicit manner or an implicit manner, that is, the UE can send the UE capability information or the service requirement information to the base station by specific signaling. The base station can obtain the UE capability information or the service requirement information by parsing the signaling. The UE can also send the UE capability information or the service requirement information to the base station in other messages in the implicit manner. When the base station parses the other messages, the base station can determine corresponding UE capability information or service requirement information by a specific rule (for example, whether related information exists) in the other messages.

The base station can receive the system information requirement message uploaded by a mobile terminal through an uplink channel of uplink physical layer signaling, or Random Access Channel (RACH),or Media Access Control (MAC) signaling, or MAC after a completion of the RACH, or Radio Resource Control (PRC) signaling. The system information requirement message is a requested message for requesting missing system information, uploaded by the UE according to the UE's own requirements. The UE's own requirements include two aspects.

After entering the cell, the UE can first receive a system information broadcast, then the UE can detect whether the broadcast (that is, the basic system information sent by the base station) can adapt to the UE's capability. When the broadcast cannot adapt to the UE's capability, an indication is sent through the uplink channel. The UE capability information is carried in the indication. The base station receives the system information requirement message.

After entering the cell, the UE can first receive a system information broadcast, then the UE can detect whether the broadcast (that is, the basic system information sent by the base station) can meet a service requirement of the UE. When the broadcast cannot meet the service requirement of the UE, the service requirement is indicated on the uplink channel. The base station receives the system information requirement message.

S108, determining target system information in the terminal-related system information according to an indication of the system information requirement message.

As mentioned in an above example, the SIB 5 mainly includes the related parameters of the common physical channel in the cell, and the SIB 6 mainly includes the related parameters of the common physical channel and the shared physical channel in the cell, etc. When the service requirement of the UE needs to use the shared physical channel, and the pre-divided basic system information includes only the SIB 5, and the SIB 6 is divided into the terminal-related system information, the UE first obtains the SIB 5 by receiving the basic system information broadcasted on the broadcast channel after entering the cell. As the service requirement of the shared physical channel needs to use the SIB 6, the service requirement of the shared physical channel is added into the system information requirement message, and the service requirement of the shared physical channel is sent to the base station through the uplink channel. After the system information request message is received, the base station can determine that the UE needs to use the SIB 6 according to the service requirement of the shared physical channel included in the system information request message. The SIB 6 can be configured as the target system information to be sent to the UE, thus the UE can perform a service using the shared physical channel.

S110, sending the target system information to the UE.

The base station can send the target system information to the mobile terminal in two modes. The target system information can be sent to the mobile terminal by adding the target system information on the broadcast channel, or the target system information can be sent to the mobile terminal through other downlink channels.

However, it should be noted that when the mobile terminal uploads the system information request message through the uplink channel of the uplink physical layer signaling, the RACH or the MAC signaling, the base station can send the target system information to the mobile terminal by adding the target system information on the broadcast channel. When the mobile terminal receives the system information request message uploaded by the mobile terminal through an uplink channel of uplink Radio Resource Control (RRC) signaling after the completion of the RACH, the base station sends the target system information to the mobile terminal through a dedicated channel corresponding to the uplink RRC signaling.

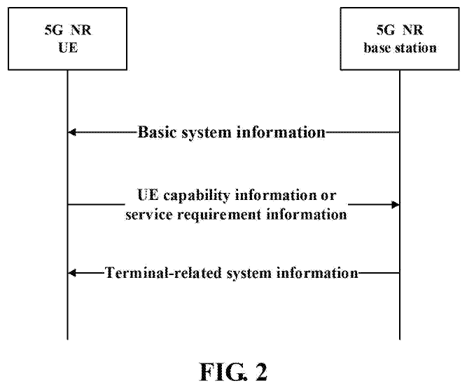

As shown in FIG. 2, FIG. 2 shows a timing sequence process that a 5th-Generation New Radio (5G NR) base station sends the system information to 5G NR UE in a 5G NR (New Radio) application scenario. The 5G NR base station broadcasts the basic system information. After the UE receives the basic system information, the UE sends the system information requirement message according to requirements. The 5G NR base station determines the target system information according to the system information requirement message, and then sends the target system information to the UE, and the UE can perform a corresponding communication service.

In another embodiment, in order to solve a technical problem in traditional technology that broadcast of system information needs to occupy a broadcast channel and an insufficient resource utilization of the broadcast channel due to an adopted level of modulation and demodulation needs to meet coverage of terminals at a center and edges, in an embodiment, a method for broadcasting system information and a corresponding method for receiving system information are further provided. The above method for broadcasting system information is based on a base station subsystem. The above method for receiving system information is based on User Equipment (UE).

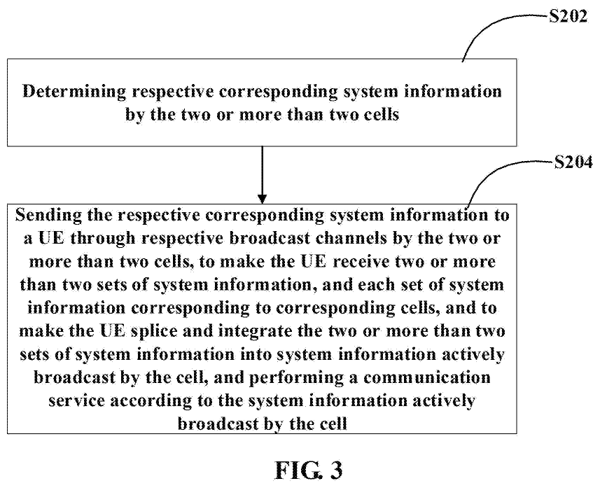

Specifically, as shown in FIG. 3, the method for broadcasting system information includes:

S202, determining respective corresponding system information by the two or more than two cells.

S204, sending the respective corresponding system information to a UE through respective broadcast channels by the two or more than two cells, to make the UE receive two or more than two sets of system information, and each set of system information corresponding to corresponding cells, and to make the UE splice and integrate the two or more than two sets of system information into system information actively broadcast by the cell, and performing a communication service according to the system information actively broadcast by the cell.

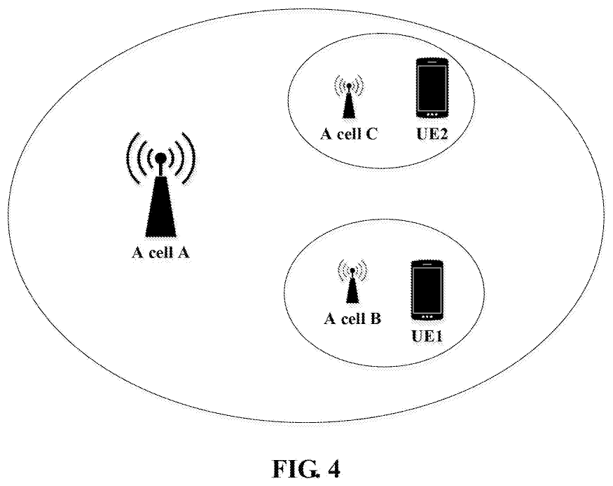

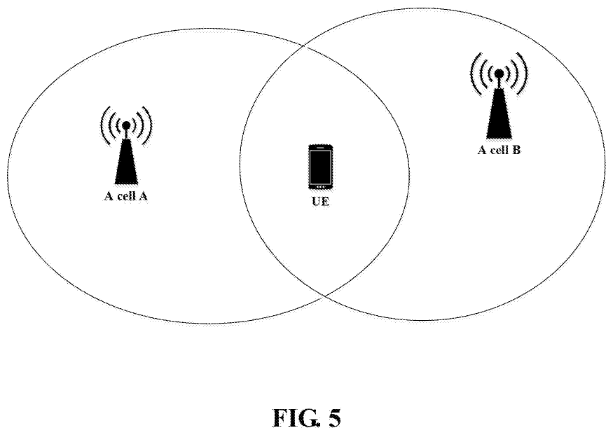

In an application scenario, as shown in FIG. 4 and FIG. 5, the UE is simultaneously covered by two cells, and the broadcast channels of the two cells can be simultaneously received. In FIG. 4, a coverage of a cell B is a subset of a coverage of a cell A, and the UE is in the coverage of the cell B. In FIG. 5, there is an intersection between the coverage of the cell B and the coverage of the cell A, and the UE is in the coverage of the intersection. A respective base station of the two cells can divide the system information actively broadcast by the cells into two parts after negotiation, and the system information needs to be sent to the UE. One part is sent to the UE through the broadcast channel of the cell A, and the other part is sent to the UE through the broadcast channel of the cell B. After receiving a part of the system information sent by a base station of the cell A and another part of the system information sent by a base station of the cell B, the UE can integrate or splicing the two parts to obtain a completed system information actively broadcast by the cell. Then the UE performs the communication service according to the system information actively broadcast by the cell.

For example, when the system information actively broadcast by the cell includes the MIB and the SIB 1 to the SIB 9, after the negotiation, the base station of the cell A broadcasts a part of system information including the MIB and the SIB 1 to the SIB 3, and the base station of the cell B broadcasts a part of system information including the SIB 4 to the SIB 9. The UE can receive the part of system information including the MIB and the SIB 1 to the SIB 3 through the broadcast channel of the base station of the cell A, and the UE can receive the part of system information including the SIB 4 to the SIB 9 through the broadcast channel of the base station of the cell B. The two parts are integrated to obtain completed system information actively broadcast by the cell of the MIB and the SIB 1 to the SIB 9.

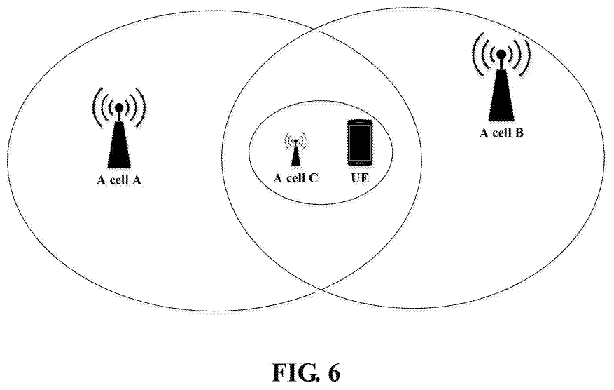

In other embodiment, as shown in FIG. 6, two or more N cells can negotiate, and the system information actively broadcast by the cell is divided into N parts, and the system information actively broadcast by the cell is broadcast separately. After receiving the N parts of the system information through the broadcast from each of the N cells, the base station integrates the system information. Then the completed system information actively broadcast by the cell is obtained.

Moreover, the two or more than two cells include a primary cell and a secondary cell. In one example as described above, the cell B can be the primary cell of a UE 1, and the cell A can be the secondary cell of the UE 1, and a cell C can be the primary cell of a UE 2 within its coverage.

Referring to the FIG. 4 again, for the UE 1, the secondary cell of the UE 1, that is, the cell A in FIG. 4, which can send cell-shared system information (that is, the system information of the cell common) to the UE 1 through the broadcast channel. The primary cell of the UE 1, that is, the cell B in FIG. 4, which can send cell-specific system information (that is, the cell-specific system information) to the UE 1 through the broadcast channel.

Similarly, for the UE 2, the secondary cell of the UE 2, that is, the cell A in FIG. 4, which can send cell-shared system information (that is, the system information of the cell common) to the UE 2 through the broadcast channel. The primary cell of the UE 2, that is, the cell C in FIG. 4, which can send cell-specific system information (that is, the cell-specific system information) to the UE 2 through the broadcast channel.

The cell-shared system information is the system information used by a plurality of cells. For example, after the cell A negotiates with the cell B, the system information actively sent by the cell is set as the MIB and the SIB 1 to the SIB 6. After the cell A negotiates with the cell C, the system information actively sent by the cell is set as the MIB and the SIB 4 to the SIB 9. Then the cell-shared system information can be determined as the MIB and the SIB 5 in advance. Then the cell A broadcast the system information of the MIB and the SIB 1 to the SIB 4. As the UE 1 and the UE 2 are both in the coverage of the cell A, and the cell A is the secondary cell of the UE 1 and the UE 2, both the UE 1 and the UE 2 can receive the system information of the cell common of the MIB and the SIB 5.

For the cell B, the cell-specific system information after the negotiation is the system information of the SIB 1 to the SIB 4 and the SIB 6, and the system information of the SIB 1 to the SIB 4 and the SIB 6 can be broadcasted by the base station corresponding to the cell B. As the UE 1 is in the coverage of the cell B, the cell-specific system information of the SIB 1 to the SIB 4 and the SIB 6 can be received. By integrating the system information of the cell common of the MIB and the SIB 5 and the system information of the cell specific of the SIB 1 to the SIB 4 and the SIB 6, the UE 1 can completely obtain the system information of the MIB and the SIB 1 to the SIB 6.

Similarly, for the cell C, the cell-specific system information after the negotiation with the cell A is the system information of the SIB 6 to the SIB 9 and the SIB 4, and the system information of the SIB 6 to the SIB 9 and the SIB 4 can be broadcasted by the base station corresponding to the cell C. As the UE 2 is in the coverage of the cell C, the cell-specific system information of the SIB 6 to the SIB 9 and the SIB 4 can be received. By integrating the system information of the cell common of the MIB and the SIB 5 and the system information of the cell specific of the SIB 6 to the SIB 9 and the SIB 4, the UE 2 can completely obtain the system information of the MIB and the SIB 4 to the SIB 9.

Optionally, as shown in FIG. 4, the primary cell can be a small cell, and the secondary cell can be a macro cell. The macro cell is a most commonly used cell design form. A traditional cellular network is composed of macro cells, and a coverage radius of each cell is mostly 1 km to 25 km. Due to a large coverage radius, the base station has a strong transmitting power, the transmitting power being generally above 10 W.

The small cell is a microcell, which is a technology developed on a basis of the macro cell. The coverage radius of the small cell is about 30 m to 300 m. The transmitting power of the small cell is small, which is generally below 1 W. The base station antenna is in a relatively low place, such as below a roof, and the base station antenna is 5 m to 10 m above the ground. A propagation is mainly along a line of sight of a street, and leak of a signal at a top of a building is small. Therefore, microcells were originally used to increase radio coverage and to eliminate ‘blind spots’ in the microcells. At the same time, as a micro-cell base station with low transmitting power allows a small frequency multiplexing distance, and a number of channels in per unit area is large, a service density is greatly increased, and a Radio Frequency (RF) interference is low. The small cell is placed in the macro cell on a ‘hot spot’ to meet requirements of both a quality and a capacity of a micro area.

In addition, after the two or more than two cells send the corresponding system information to the UE through the respective broadcast channels, when the system information that the UE actively send through the integrated cell does not fully satisfy the UE capability or the service requirement, the UE capability or the service requirement can be sent through the uplink channel of the primary cell. It should be noted that the manner in which the two or more than two cells send the corresponding system information to the UE is not limited to being sent through the broadcast channel, the two or more than two cells can also send the corresponding system information to the UE through dedicated signaling described in other standards.

The primary cell can receive the message sent by the UE through the uplink channel, and extract the UE capability information or the service requirement information included in the message, and determine supplemental system information according to the indication of the UE capability information or the service requirement information, and send the supplementary system information to the UE to make the UE perform the communication service according to the system information integrated by the system information actively broadcast by the cell and the supplementary system information.

As in the above example, when the system information received by the UE 1 is the system information of the cell common of the MIB and the SIB 5, and the system information of the cell specific of the SIB 1 to the SIB 4 and the SIB 6. The received system information actively broadcast by the cell is the MIB and the SIB 1 to the SIB 6. The UE 1 further needs the system information of an SIB 12 according to the UE capability or the service requirement. Then the UE 1 can send the UE capability information or the service requirement information (which can be explicitly included or implicitly included) to the cell B through the uplink channel of the cell B. After receiving the system information requirement message, the base station of the cell B can determine the system information of the SIB 12 as the supplementary system information. Then the SIB 12 is transmitted to the UE 1 through the broadcast or other downlink channel, and the UE 1 can perform corresponding communication service.

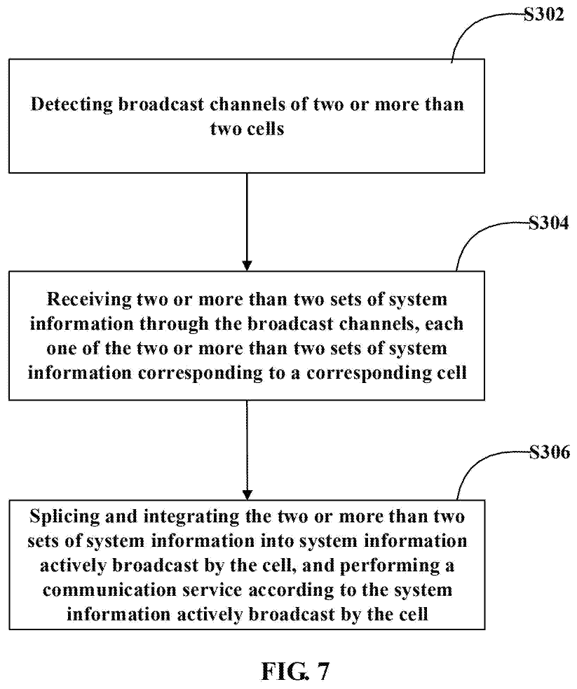

In this process, correspondingly, UE also performs a method for receiving system information corresponding to the method for broadcasting the system information, as shown in FIG. 7, the method for receiving system information specifically includes:

S302, detecting broadcast channels of two or more than two cells.

S304, receiving two or more than two sets of system information through the broadcast channels, each one of the two or more than two sets of system information corresponding to a corresponding cell.

S306, splicing and integrating the two or more than two sets of system information into system information actively broadcast by the cell, and performing a communication service according to the system information actively broadcast by the cell.

Correspondingly, the UE can receive the cell-specific system information through the broadcast channel of the primary cell in the two or more than two cells, and the UE can receive the cell-shared system information through the broadcast channel of the secondary cell in the two or more than two cells.

After splicing and integrating the two or more than two sets of system information into system information actively broadcast by the cell, the UE can also determine whether the system information actively broadcast by the cell meets the UE capability information or the service requirement information, and when the system information actively broadcast by the cell does not meet the UE capability information or the service requirement information, reporting the UE capability information or the service requirement information to the primary cell in the two or more than two cells through the uplink channel. Receiving the supplemental system information sent by the primary cell according to the UE capability information or the service requirement information. Performing the communication service according to the system information integrated by the system information actively broadcast by the cell and the supplementary system information.

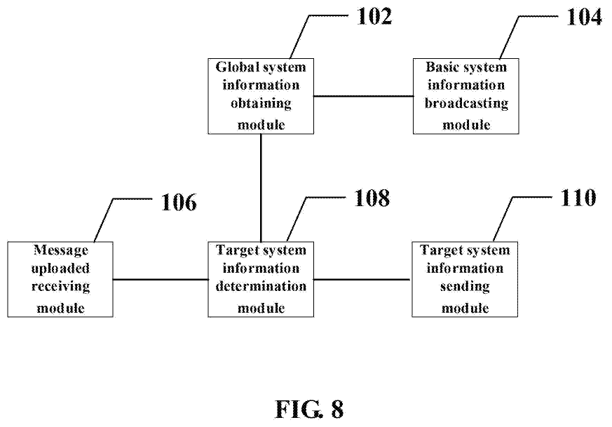

In addition, in order to solve a technical problem in traditional technology that broadcast of system information needs to occupy a broadcast channel and an insufficient resource utilization of the broadcast channel due to an adopted level of modulation and demodulation needs to meet coverage of terminals at a center and edges, in one embodiment, as shown in FIG. 8, a device for broadcasting system information is provided, which includes a global system information obtaining module 102, a basic system information broadcasting module 104, a message uploaded receiving module 106, a target system information determination module 106, and a target system information sending module 110.

The global system information obtaining module 102 configured to obtain preset global system information, the global system information including pre-divided basic system information and terminal-related system information.

The basic system information broadcasting module 104 configured to broadcast the basic system information on a broadcast channel.

The message uploaded receiving module configured 106 to receive a message uploaded by User Equipment (UE) through an uplink channel, and extract a system information requirement message included in the message.

The target system information determination module 108 configured to determine target system information in the terminal-related system information according to an indication of the system information requirement message.

The target system information sending module 110 configured to send the target system information to the UE.

In one embodiment, the message uploaded receiving module 106 is further configured to receive the message uploaded by the UE through an uplink channel of uplink physical layer signaling, Random Access Channel (RACH) or Media Access Control (MAC) signaling. The target system information sending module 110 is further configured to add the target system information on the broadcast channel.

In one embodiment, the message uploaded receiving module 106 is further configured to receive the message uploaded by the UE through the uplink channel of uplink Radio Resource Control (RRC) signaling. The target system information sending module 110 is further configured to send the target system information to the UE through a dedicated channel corresponding to the uplink RRC signaling.

In one embodiment, the system information requirement message is UE capability information or service requirement information.

In one embodiment, the message uploaded receiving module 106 is further configured to extract the system information requirement message included in the messages in an explicit manner or an implicit manner.

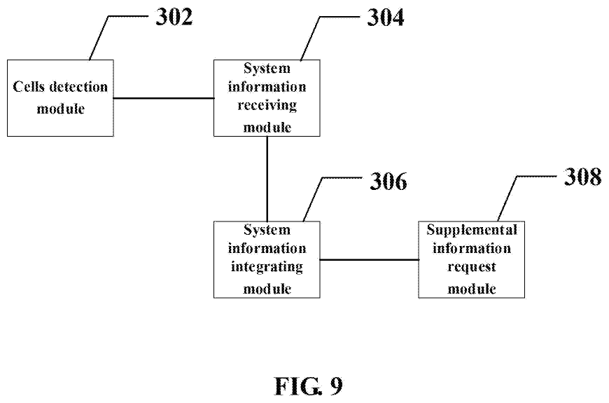

In addition, in order to solve a technical problem in traditional technology that broadcast of system information needs to occupy a broadcast channel and an insufficient resource utilization of the broadcast channel due to an adopted level of modulation and demodulation needs to meet coverage of terminals at a center and edges, in one embodiment, as shown in FIG. 9, a device for receiving system information, which includes a cells detection module 302, a system information receiving module 304 and a system information integrating module 306.

A cells detection module 302 configured to detect broadcast channels of two or more than two cells.

A system information receiving module 304 configured to receive two or more than two sets of system information through the broadcast channels, each one of the two or more than two sets of system information corresponding to a corresponding cell.

A system information integrating module 306 configured to splice and integrate the two or more than two sets of system information into system information actively broadcast by the cell, and perform a communication service according to the system information actively broadcast by the cell.

In one embodiment, the two or more than two cells include a primary cell and a secondary cell.

The system information receiving module 306 is further configured to receive cell-specific system information by a broadcast channel of the primary cell in the two or more than two cells, and receive cell-shared system information by a broadcast channel of the secondary cell in the two or more than two cells.

In one embodiment, as shown in FIG. 9, the device further includes a supplemental information request module 308, which is configured to determine whether the system information actively broadcast by the cell meets User Equipment (UE) capability information or service requirement information, and when the system information actively broadcast by the cell does not meet the UE capability information or the service requirement information, report the UE capability information or the service requirement information to the primary cell in the two or more than two cells through an uplink channel, and receive supplemental system information sent by the primary cell according to the UE capability information or the service requirement information, and perform the communication service according to the system information integrated by the system information actively broadcast by the cell and the supplementary system information.

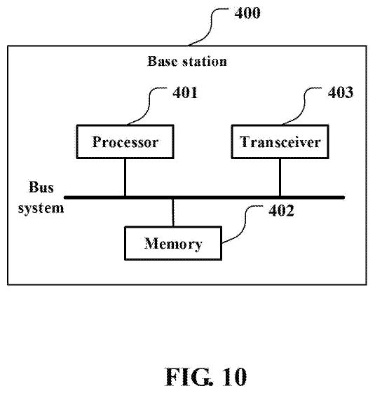

As shown in FIG. 10, a base station is further provided in an embodiment of the present disclosure. A base station 400 includes a processor 401, a memory 402 and a transceiver 403. The transceiver 403 is used to send and receive data from external devices. A number of the processor 401 of the base station 400 maybe one or more than one. In some embodiments of the present disclosure, the processor 401, the memory 402 and the transceiver 403 can be connected through a bus system or in other ways. The base station 400 can be used to execute the method shown in FIG. 1 and in FIG. 3.

The memory 402 stores program codes. The processor 401 can invoke the program codes stored in the memory 402 to execute the following operations through a bus system. For example, respective modules described in FIG. 8 (for example, a global system information obtaining module 102, a basic system information broadcasting module 104, a message uploaded receiving module 106, a target system information determination module 106, and a target system information sending module 110, etc.) are the program codes stored in the memory 402 and executed by the processor 401 to implement the functions of the respective modules to implement a method for broadcasting system information.

Specifically, the processor 401 executes the following operations: obtaining preset global system information, the global system information including pre-divided basic system information and terminal-related system information; broadcasting the basic system information on a broadcast channel; receiving a message uploaded by User Equipment (UE) through an uplink channel, and extracting a system information requirement message included in the message; determining target system information in the terminal-related system information according to an indication of the system information requirement message.

The processor 401 further executes the following operations: detecting broadcast channels of two or more than two cells; splicing and integrating the two or more than two sets of system information into system information actively broadcast by the cell, and performing a communication service according to the system information actively broadcast by the cell.

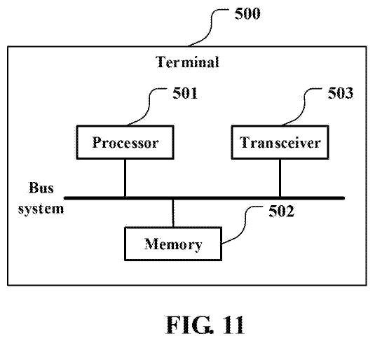

As shown in FIG. 11, a terminal is further provided in an embodiment of the present disclosure. A terminal 500 includes a processor 501, a memory 502 and a transceiver 503. The transceiver 503 is used to send and receive data from external devices. A number of the processor 501 of the terminal 500 maybe one or more than one. In some embodiments of the present disclosure, the processor 501, the memory 502 and the transceiver 503 can be connected through a bus system or in other ways. The terminal 500 can be used to execute the method shown in FIG. 7.

The memory 502 stores program codes. The processor 501 can invoke the program codes stored in the memory 502 to execute the following operations through a bus system. For example, respective modules described in FIG. 9 (for example, a cells detection module 302, a system information receiving module 304, a system information integrating module 306, and a supplemental information request module 308, etc.) are the program codes stored in the memory 502 and executed by the processor 501 to implement the functions of the respective modules to implement a method for receiving system information.

Specifically, the processor 501 executes the following operations: detecting broadcast channels of two or more than two cells; receiving two or more than two sets of system information through the broadcast channels, each one of the two or more than two sets of system information corresponding to a corresponding cell; splicing and integrating the two or more than two sets of system information into system information actively broadcast by the cell, and performing a communication service according to the system information actively broadcast by the cell.

Implementation of embodiments of the present disclosure has the following beneficial effects:

After adopting a method, a device, and a system for broadcasting system information as described above, a base station only needs to use less broadcast resources to broadcast preset basic system information. After User Equipment (UE) receives the basic system information through a broadcast channel, when the basic system information adapts capabilities of the UE or meets service requirements of the UE, a corresponding communication service may be performed. Only when the basic system information does not adapt to the capabilities of the UE or does not meet the service requirements of the UE, the base station needs to send the system information required by the UE to the UE. Thus a number of SIBs defined by a timely communication protocol is more, and less resources of the broadcast channel are consumed to send the system information to the base station, thereby improving resource utilization of the broadcast channel.

The above mentioned descriptions are merely preferred embodiments of the present disclosure, and certainly, should not limit the scope of the present disclosure. Thus, any modification and equivalent according to the claims of the present disclosure, should be still within the scope of the present disclosure.

1. A method for broadcasting system information, comprising:
obtaining preset global system information, the global system information comprising pre-divided basic system information and terminal-related system information;
broadcasting the pre-divided basic system information on a broadcast channel;
receiving a message uploaded by User Equipment (UE) through an uplink channel, and extracting a system information requirement message from the message;
determining target system information in the terminal-related system information according to an indication of the system information requirement message; and
sending the target system information to the UE.

2. The method for broadcasting system information of claim 1:
wherein receiving the message uploaded by the UE through the uplink channel comprises:
receiving the message uploaded by the UE through an uplink channel of uplink physical layer signaling, Random Access Channel (RACH) or Media Access Control (MAC) signaling;
wherein sending the target system information to the UE comprises:
adding the target system information on the broadcast channel.

3. The method for broadcasting system information of claim 1:
wherein receiving the message uploaded by the UE through the uplink channel comprises:
receiving the message uploaded by the UE through the uplink channel of uplink Radio Resource Control (RRC) signaling;
wherein sending the target system information to the UE comprises:
sending the target system information to the UE through a dedicated channel corresponding to the uplink RRC signaling.

4. The method for broadcasting system information of claim 1, wherein the system information requirement message is UE capability information or service requirement information.

5. The method for broadcasting system information of claim 1, wherein extracting the system information requirement message from the messages comprises:
extracting the system information requirement message from the messages in an explicit manner or an implicit manner.

6-24. (canceled)

25. The method for broadcasting system information of claim 1, further comprising:
determining respective corresponding system information by two or more than two cells;
sending the respective corresponding system information to the UE through respective broadcast channels by the two or more than two cells, wherein the UE receives two or more than two sets of system information, and each set of system information corresponds to a corresponding one of the cells, and wherein the UE splices and integrates the two or more than two sets of system information into system information actively broadcast by the cell, and performs a communication service according to the system information actively broadcast by the cell.

26. The method for broadcasting system information of claim 25, wherein the two or more than two cells comprise a primary cell of the UE and a secondary cell of the UE, and wherein sending the respective corresponding system information to the UE through the respective broadcast channels by the two or more than two cells comprises:
sending cell-specific system information to the UE through a broadcast channel by the primary cell of the UE;
sending cell-shared system information to the UE through a broadcast channel by the secondary cell of the UE.

27. The method for broadcasting system information of claim 26, after sending the respective corresponding system information to the UE through the respective broadcast channels by the two or more than two cells, further comprising:
receiving messages uploaded by the UE through an uplink channel, and extracting UE capability information or service requirement information from the messages by the primary cell of the UE;
determining supplemental system information according to an indication of the UE capability information or the service requirement information;
sending the supplementary system information to the UE wherein the UE performs the communication service according to the system information integrated by the system information actively broadcast by the cell and the supplementary system information.

28. A base station, comprising:
at least one processor; and
a storage device storing a plurality of instructions, which when executed by the processor, causes the at least one processor to:
obtain preset global system information, the global system information comprising pre-divided basic system information and terminal-related system information;
broadcast the basic system information on a broadcast channel;
receive a message uploaded by User Equipment (UE) through an uplink channel, and extract a system information requirement message from the message;
determine target system information in the terminal-related system information according to an indication of the system information requirement message; and
send the target system information to the UE.

29. The base station of claim 28, wherein the at least one processor is further caused to:
receive the message uploaded by the UE through an uplink channel of uplink physical layer signaling, Random Access Channel (RACH) or Media Access Control (MAC) signaling; and
add the target system information on the broadcast channel.

30. The base station of claim 28, wherein the at least one processor is further caused to:
receive the message uploaded by the UE through the uplink channel of uplink Radio Resource Control (RRC) signaling; and
send the target system information to the UE through a dedicated channel corresponding to the uplink RRC signaling.

31. The base station of claim 28, wherein the system information requirement message is UE capability information or service requirement information.

32. The base station of claim 28, wherein the at least one processor is further caused to:
extract the system information requirement message from the messages in an explicit manner or an implicit manner.

33. The base station of claim 28, wherein two or more than two cells determine respective corresponding system information, and send the respective corresponding system information to the UE through respective broadcast channels, and the UE receives two or more than two sets of system information, each set of system information corresponds to a corresponding one of the cells, and splices and integrates the two or more than two sets of system information into system information actively broadcast by the two or more than two cells, and performs a communication service according to the system information actively broadcast by the cell.

34. The base station of claim 33, wherein the two or more than two cells comprise a primary cell of the UE and a secondary cell of the UE, and the two or more than two cells send cell-specific system information to the UE through the broadcast channel, and send cell-shared system information to the UE through the broadcast channel.

35. The base station of claim 34, wherein the two or more than two cells receive messages uploaded by the UE through the uplink channel, and extract the UE capability information or the service requirement information from the messages, and determine supplemental system information according to an indication of the UE capability information or the service requirement information, and send the supplementary system information to the UE, and the UE performs the communication service according to the system information integrated by the system information actively broadcast by the two or more than two cells and the supplementary system information.

36. A non-transitory storage medium having stored thereon instructions that, when executed by a processor of a base station, causes the processor of the base station to perform a method for broadcasting system information, the method comprising:
obtaining preset global system information, the global system information comprising pre-divided basic system information and terminal-related system information;
broadcasting the pre-divided basic system information on a broadcast channel;
receiving a message uploaded by User Equipment (UE) through an uplink channel, and extracting a system information requirement message from the message;
determining target system information in the terminal-related system information according to an indication of the system information requirement message; and
sending the target system information to the UE.

37. The non-transitory storage medium according to claim 36:
wherein receiving the message uploaded by the UE through the uplink channel comprises:
receiving the message uploaded by the UE through an uplink channel of uplink physical layer signaling, Random Access Channel (RACH) or Media Access Control (MAC) signaling;
wherein sending the target system information to the UE comprises:
adding the target system information on the broadcast channel.

38. The non-transitory storage medium according to claim 36:
wherein receiving the message uploaded by the UE through the uplink channel comprises:
receiving the message uploaded by the UE through the uplink channel of uplink Radio Resource Control (RRC) signaling;
wherein sending the target system information to the UE comprises:
sending the target system information to the UE through a dedicated channel corresponding to the uplink RRC signaling.

39. The non-transitory storage medium according to claim 36, wherein the system information requirement message is UE capability information or service requirement information.
